(19) United States
(12) Patent Application Publication
(10) Pub. No.: US 2010/0085259 A1
(43) Pub. Date: Apr. 8, 2010

(54) PLANAR ANTENNA

(75) Inventors: Shao-Chin Lo, Hsinchu (TW); Yu-De Liao, Hsinchu (TW)

Correspondence Address: EDWARDS ANGELL PALMER & DODGE LLP, P.O. BOX 55874, BOSTON, MA, 02205, US

(73) Assignee: Ralink Technology Corporation, Hsinchu (TW)

(21) Appl. No.: 12/547,026

(22) Filed: Aug. 25, 2009

(30) Foreign Application Priority Data
Oct. 7, 2008 (TW) 097138508

(51) Int. Cl. H01Q 1/38

(52) U.S. Cl. 343/700 MS

(57) ABSTRACT

The present invention provides a planar antenna, including an inverted F-shaped antenna module having a first resonance unit, a second resonance unit and a linear feed-in unit, and a linear ground unit, wherein the linear ground unit is perpendicularly connected to the first and second resonance units to form a rectangular resonance cavity, the two resonance units have the same signal feed-in end but different widths, thereby resulting in different route lengths for generation of two sets of signals with different frequency responses. Further, by adjusting frequency bands of the two sets of signals with optimal responses to achieve a signal coupling resonance effect, signals with frequencies matching the resonant frequencies achieve high gain and high radiation efficiency and signals with frequencies different from the resonant frequencies are suppressed and cannot be efficiently radiated.

### BACKGROUND OF THE INVENTION

1. Field of the Invention

The present invention relates generally to a planar antenna, and more particularly to a printed circuit planar antenna.

2. Description of Related Art

Wireless communication transmits signals through electromagnetic waves without the need of actual cables. Along with the increasing demands for wireless communication, wireless communication technology and devices have been rapidly developed.

Since wireless communication and wired communication have different signal transmission media, the probabilities that signal interference occurs to wireless communication devices and wired communication devices are different. In particular, wired communication signals are transmitted between distinct devices that provide good signal isolation. On the other hand, wireless communication signals are transmitted in free space that often leads to signal interference.

For example, Taiwan patent No. 1286855 discloses a configuration of antennas with same frequency band on a printed circuit board. As disclosed in Taiwan patent No. 1286855, for a wireless communication device that provides two more kinds of communication systems, even though the communication systems use different technologies such as modulation and spread spectrum, signal interference occurs when receiving and transmitting frequency bands of the two systems overlap.

To solve this drawback, Taiwan patent No. 1286855 provides a method of disposing antennas with same frequency band at two isolated corners of a substrate, thereby avoiding interference between two wireless signals.

However, with the trend of miniaturization of wireless hardware devices, available space is reduced and accordingly the effect achieved through such a method is quite limited.

Therefore, in the case the space isolation cannot be applied to avoid wireless signal interference, it is an urgent issue to use adjacent signal coupling effect to provide a technique for suppressing adjacent signal interference and filtering noises and strengthening specific signals.

### SUMMARY OF THE INVENTION

According to the above drawbacks, the present invention discloses a planar antenna so as to provide a technique for suppressing adjacent signal interference, thereby filtering noises and strengthening specific signals.

The present invention provides a planar antenna, which comprises: an antenna module having a first resonance unit, a second resonance unit and a linear feed-in unit; and a linear ground unit perpendicularly connected to the first resonance unit and the second resonance unit to form a rectangular resonance cavity.

In the present invention, the first resonance unit and the second resonance unit are perpendicularly connected to the linear feed-in unit, respectively, and have a same signal feed-in end, and the first and second resonance units are arranged to form an inverted F-shaped antenna module having an array of antennas arranged in parallel.

Further, the width of the first resonance unit is different from the width of the second resonance unit such that for signals fed in through the linear feed-in unit, and the signal route through the first resonance unit and the signal route through the second resonance unit have different lengths, thereby resulting in different frequency responses. The linear feed-in unit and the first resonant unit generate a first frequency response, and the linear feed-in unit and the second resonant unit generate a second frequency response.

The first frequency response and the second frequency response have the same set of resonant frequencies for forming signal coupling resonance such that signals matching the resonant frequencies are strengthened while signals with frequencies different from the resonant frequencies are suppressed due to a filtering effect.

Preferably, the planar antenna is fabricated through a printed circuit fabrication technique and the planar antenna is applicable to WLAN cards. The planar antenna further comprises a printed circuit substrate, and the antenna module and the linear ground unit are disposed on the same surface of the printed circuit substrate.

The width of the linear feed-in unit and the width of the linear ground unit are 39.4 mil, the width of the first resonance unit is 39.4 mil, the width of the second resonance unit is 61.3 mil, the length of the rectangular resonance cavity is 111.7 mil and the width of the rectangular resonance cavity is 79.5 mil. Through the above design, the antenna of the present invention can be used to provide wireless radio frequency signals with optimal resonance effect at a frequency band of 2400 MHz to 2500 MHz.

Particularly, the planar antenna of the present invention comprises an inverted F-shaped module having a first resonance unit, a second resonance unit and a linear feed-in unit, and a linear ground unit perpendicularly connected to the first resonance unit and the second resonance unit so as to form a rectangular resonance cavity. The two resonance units have the same signal feed-in end and have different widths.

Different widths of the two resonance units of the planar antenna lead to different route lengths for signal transmission, thereby generating two sets of signals having different frequency responses. Further, the frequency bands of the two sets of signals with optimal responses are adjusted to achieve a signal coupling resonance effect such that signals matching the resonant frequencies can achieve high gain and high radiation efficiency while signals having frequencies different from the resonant frequencies can be suppressed and cannot be efficient radiated.

Therefore, the present invention uses adjacent signal coupling effect to provide a technique for suppressing adjacent signal interference, thereby filtering noises and strengthening specific signals.

### BRIEF DESCRIPTION OF DRAWINGS

FIG. 1 is a diagram showing a planar antenna according to the present invention;

FIG. 2a is a diagram showing a first frequency response of the planar antenna according to the present invention;

FIG. 2b is a diagram showing a second frequency response of the planar antenna according to the present invention;

FIG. 2c is a diagram showing coupled signal frequency response of the planar antenna according to the present invention; and

FIG. 3 is a diagram showing an application structure of the planar antenna according to the present invention.

### DETAILED DESCRIPTION OF PREFERRED EMBODIMENTS

The following illustrative embodiments are provided to illustrate the disclosure of the present invention, these and other advantages and effects can be apparent to those skilled in the art after reading the disclosure of this specification.

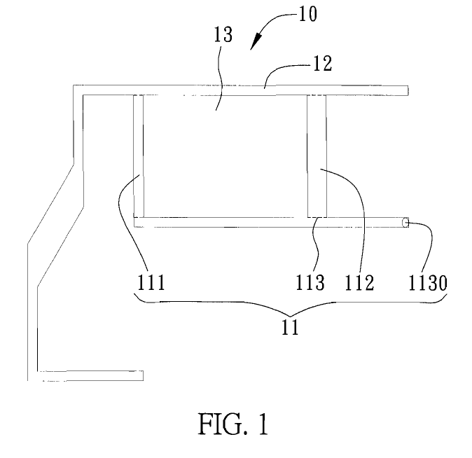

FIG. 1 shows a planar antenna of the present invention. As shown in the drawing, the planar antenna 10 of the present invention comprises an antenna module 11 having a first resonance unit 111, a second resonance unit 112 and a linear feed-in unit 113; and a linear ground unit 12 perpendicularly connected to the first resonance unit 111 and the second resonance unit 112 so as to form a rectangular resonance cavity 13.

Preferably, the planar antenna 10 is integrally formed by using a printed circuit fabrication technique. The dashed lines in FIG. 1 only indicate relative positions of the elements, which are not necessary in practice.

The first resonance unit 111 and the second resonance unit 112 are perpendicularly connected to the linear feed-in unit 113, respectively, and have the same signal feed-in end 1130, thereby forming an inverted F-shaped antenna module 11 with an array of antennas arranged in parallel.

Further, the width of the first resonance unit 111 is different from that of the second resonance unit 112. As a result, for signals fed in through the linear feed-in unit 113, the signal route through the first resonance unit 111 and the signal route through the second resonance unit 112 have different lengths, thereby radiating two sets of wireless radio frequency signals with different frequency responses.

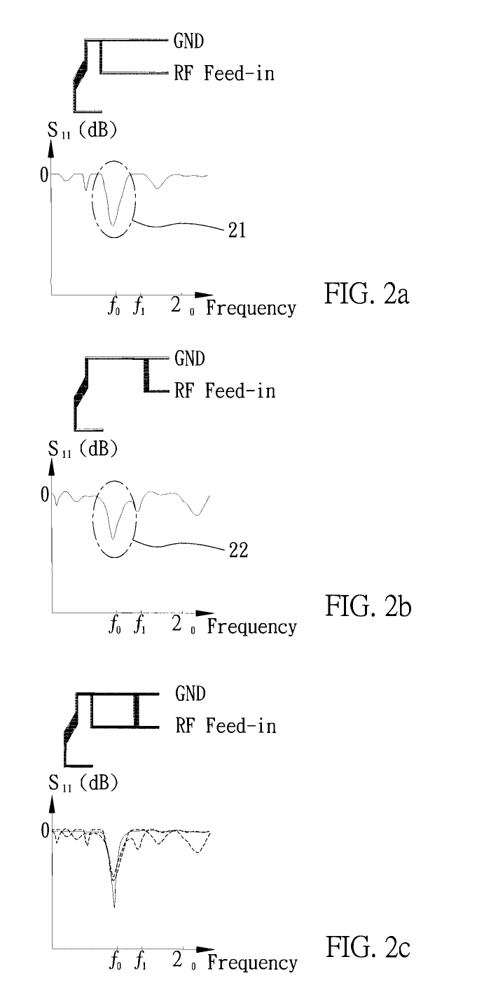

FIGS. 2a and 2b show a first frequency response and a second frequency response of the planar antenna of the present invention, wherein FIG. 2a shows a first frequency response curve generated by the linear feed-in unit and the first resonance unit, and FIG. 2b shows a second frequency response curve generated by the linear feed-in unit and the second resonance unit. As shown in FIGS. 2a and 2b, the first frequency response and the second frequency response have a distinct first resonant frequency band 21 and a distinct second resonant frequency band 22, respectively.

FIG. 2c shows a coupled signal frequency response of the planar antenna of the present invention. By adjusting the width 1110 of the first resonance unit 111 and the width 1120 of the second resonance unit 112, the first resonant frequency band 21 and the second resonant frequency band 22 are adjusted to have the same set of resonant frequencies such that signals matching the resonant frequencies are strengthened by resonance while signals with frequencies different from the resonant frequencies are suppressed due to a filtering effect caused by different signal interference.

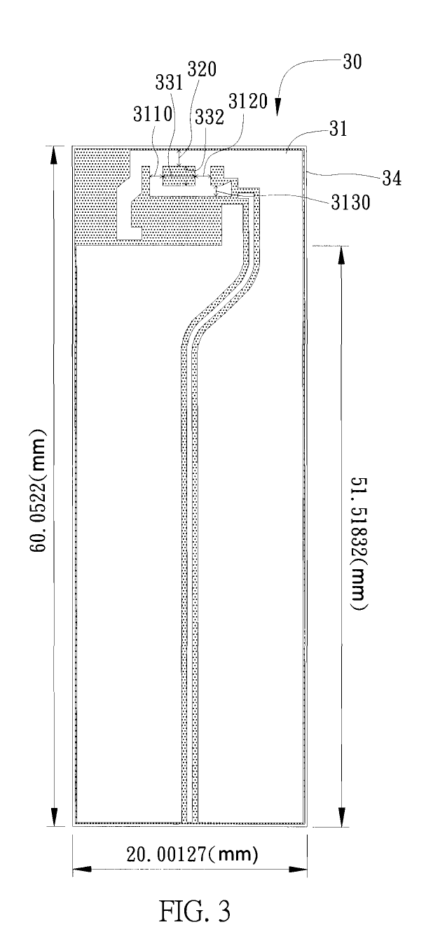

FIG. 3 shows an application structure of the planar antenna of the present invention. Preferably, a printed circuit fabrication technique is used to fabricate an antenna device 30, which comprises a printed circuit substrate 34, an antenna module (not shown) and a linear ground unit (not shown), wherein the antenna module and the linear ground unit are disposed on the same surface of the printed circuit substrate 34, and the antenna module further comprises a first resonance unit (not shown), a second resonance unit (not shown) and a linear feed-in unit (not shown) so as to form a rectangular resonance cavity 33.

Preferably, the width 3130 of the linear feed-in unit and the width 320 of the linear ground unit are 39.4 mil, the width 3110 of the first resonance unit is 39.4 mil, the width 3120 of the second resonance unit is 61.3 mil, the length 331 of the rectangular resonance cavity is 111.7 mil and the width 332 of the rectangular resonance cavity is 79.5 mil. Through the above-disclosed embodiments, the present invention uses adjacent signal coupling effect to filter noises and strengthen specific signals, thereby providing wireless radio frequency signals having optimal resonance effect at a frequency band of about 2400 MHz to 2500 MHz and applicable in WLAN cards.

In particular, different widths of the two resonance units of the planar antenna lead to different route lengths for signal transmission, thereby generating two sets of signals having different frequency responses. Further, the frequency bands of the two sets of signals with optimal responses are adjusted to achieve a signal coupling resonance effect such that signals matching the resonant frequencies can achieve high gain and high radiation efficiency while signals having frequencies different from the resonant frequencies can be suppressed and cannot be efficient radiated.

Therefore, the present invention uses adjacent signal coupling effect to provide a technique for suppressing adjacent signal interference, thereby filtering noises and strengthening specific signals.

The above-described descriptions of the detailed embodiments are only to illustrate the preferred implementation according to the present invention, and it is not to limit the scope of the present invention. Accordingly, all modifications and variations completed by those with ordinary skill in the art should fall within the scope of present invention defined by the appended claims.

What is claimed is:

1. An antenna, comprising:
an antenna module having a first resonance unit, a second resonance unit and a linear feed-in unit; and
a linear ground unit perpendicularly connected to the first resonance unit and the second resonance unit to form a rectangular resonance cavity.

2. The antenna of claim 1, wherein the antenna module is an inverted F-shaped antenna module.

3. The antenna of claim 1, wherein the first resonance unit and the second resonance unit have a same signal feed-in end.

4. The antenna of claim 1, wherein the first resonance unit and the second resonance unit are perpendicularly connected to the linear feed-in unit.

5. The antenna of claim 1, wherein the width of the first resonance unit is different from the width of the second resonance unit.

6. The antenna of claim 5, wherein for signals fed in through the linear feed-in unit, the signal route through the first resonance unit and the signal route through the second resonance unit have different lengths.

7. The antenna of claim 6, wherein the linear feed-in unit and the first resonance unit generate a first frequency response, and the linear feed-in unit and the second resonance unit generate a second frequency response.

8. The antenna of claim 7, wherein the first frequency response is different from the second frequency response.

9. The antenna of claim 7, wherein the first frequency response and the second frequency response have a same set of resonant frequencies.

10. The antenna of claim 9, wherein in the first frequency response and the second frequency response, signals matching the resonant frequencies are strengthened by resonance.

11. The antenna of claim 9, wherein signals with frequencies different from the resonant frequencies are suppressed.

12. The antenna of claim 1, wherein the first resonance unit and the second resonance unit are arranged to form an antenna array.

13. The antenna of claim 12, wherein the first resonance unit and the second resonance unit are arranged in parallel.

14. The antenna of claim 1, wherein the width of the linear feed-in unit and the width of the linear ground unit are 39.4 mil.

15. The antenna of claim 14, wherein the width of the first resonance unit is 39.4 mil, and the width of the second resonance unit is 61.3 mil.

16. The antenna of claim 15, wherein the length and width of the rectangular resonance cavity are 111.7 mil and 79.5 mil, respectively.

17. The antenna of claim 16, wherein the planar antenna has an optimal resonance effect at a frequency band of 2400 MHz to 2500 MHz.

18. The antenna of claim 1, further comprising a printed circuit substrate.

19. The antenna of claim 18, wherein the antenna module and the linear ground unit are disposed on a same surface of the printed circuit substrate.
